(19) United States
(12) Patent Application Publication
(10) Pub. No.: US 2015/0096669 A1
(43) Pub. Date: Apr. 9, 2015

(54) METHOD FOR MANUFACTURING PICTURE FRAME AND SYSTEM THEREOF

(71) Applicant: TECHADHESION SYTEMS LIMITED, Shenzhen, Guangdong (CN)

(72) Inventor: Dianmin Zhou, Shenzhen (CN)

(21) Appl. No.: 14/357,652

(22) PCT Filed: Jun. 28, 2012
(86) PCT No.: PCT/CN2012/077699

§ 371 Date: May 12, 2014

(51) Int. Cl. A47G 1/06; B32B 38/00

(52) U.S. Cl. CPC A47G 1/06; B32B 38/0012; B32B 38/0004
USPC 156/217; 156/477.1; 156/389; 156/378

(57) ABSTRACT

The present invention relates to a method for manufacturing a picture frame and a system thereof. The method adopts a wire as workpiece to manufacture the picture frame and comprises the steps of edge milling, glue application, workpiece turnover, folding and picture frame solidifying. The system is a production line and operates under the control of a control system. The system comprises an edge milling machine, a glue sprayer, a workpiece turnover machine, an automatic picture frame folding machine and a conveyor belt for connecting the edge milling machine, the glue sprayer and the automatic picture frame folding machine, in the production line. The method and the system for manufacturing the picture frame provided by the present invention achieve the automatic production of picture frames, improve the work efficiency and have a simple and controllable production line.

### FIELD OF THE INVENTION

The present invention relates to the field of industrial automatic production of picture frames, in particular to a method for manufacturing a picture frame and a system thereof.

### BACKGROUND OF THE INVENTION

A common picture frame is similar to a square; a frame is disposed on the periphery; the inside is hollowed-out; and a photo can be placed on a blank space. The main part of the picture frame is the frame. A current common square picture frame is an enclosed empty frame which is surrounded by head and tails of four wires.

Currently, picture frame wires are usually adopted to manufacture picture frames in the production process of the picture frames. Picture frame wires are materials for manufacturing picture frames and are generally made of aluminum alloy, wood or other materials. The shape of a picture frame wire is as shown in FIG. 1. The picture frame wire is an integral wire 01; a recess 02 is formed inwards on the front face of the wire 01; as illustrated in FIG. 1a, the wire 01 can be divided into four sections; as illustrated in FIGS. 1b and 1c, two sections 04 and 06 have equal length and are two opposite sides of the picture frame, and two sections 05 and 07 have equal length and are two opposite sides of the picture frame; three notches 03 are cut out on the wire 01 by a cutting machine; as illustrated in FIG. 1b, cross sections of the notches are in the shape of isosceles right-angled triangles; an incline 08 is respectively cut out at both ends of the wire; the inclines 08 at both ends are also in the shape of an isosceles right-angled triangle when combined; an adhesive is sprayed on the notches 03 and the inclines 08; all the sections are bent to form a square; the notches 03 and the inclines 08 are matched with each other; and the picture frame is formed.

Currently, the method for manufacturing the picture frame by the wire adopts the means of manual cutting, glue spraying and bending and forming to manufacture the picture frame. As manual work and simple machines are adopted, the production efficiency is relatively low and the cost is high.

### SUMMARY OF THE INVENTION

The present invention overcomes the defects of low production efficiency and high cost due to the adoption of simple machines and semi-hand means and provides a method for automatically manufacturing a picture frame by a wire and a system thereof.

The present invention provides a method for manufacturing a picture frame at first, which adopts a wire as workpiece to manufacture the picture frame and comprises the steps of edge milling, glue application, workpiece turnover, folding and picture frame solidifying, wherein the folding step includes:

primary folding, in which notches on both sides of the workpiece are folded inwards so that a first section and a fourth section of the workpiece are respectively perpendicular to a second section and a third section; and

secondary folding, in which a notch in the middle of the workpiece is folded in such a way that the second section and the third section of the workpiece are perpendicular to each other, and at this point, inclines on both sides of the first section and the fourth section in the workpiece are overlapped to form an enclosed frame.

Moreover, in the method for manufacturing the picture frame, the workpiece must be subjected to dust removal after edge milling.

Moreover, in the method for manufacturing the picture frame, in the step of edge milling, three notches of which cross sections are in the shape of isosceles right-angled triangles are milled on the wire to divide the wire into four sections to form the workpiece, in which the first section and the third section have equal length and the second section and the fourth section have equal length; and an incline with the angle of 45 degree is respectively milled at head and tail of the wire.

Moreover, in the method for manufacturing the picture frame, in the gluing step, hot-melt adhesive guns are adopted to spray a hot melt adhesive on the three notches and the two inclines in the workpiece at the same time.

Moreover, in the method for manufacturing the picture frame, in the step of workpiece turnover, the workpiece after glue spraying is turned over 90 degree.

Meanwhile, the present invention further provides a manufacturing system designed according to the method for manufacturing the picture frame. The system is a production line and operates under the control of a control system. The system comprises an edge milling machine, a glue sprayer, a workpiece turnover machine, an automatic picture frame folding machine and a conveyor belt for connecting the edge milling machine, the glue sprayer and the automatic picture frame folding machine, wherein

the automatic picture frame folding machine includes a first folding machine and a second folding machine; the first folding machine is disposed on the downstream part of the glue sprayer on the conveyor belt and includes a first folding arm, a second folding arm, a first extrude bar and a second extrude bar; the first extrude bar and the second extrude bar are disposed in parallel on the conveyor belt at the distance of the total length of the second section and the third section in the workpiece; the first folding arm and the second folding arm are symmetrically and respectively disposed at front ends of the first extrude bar and the second extrude bar and expanded outward;

the second folding machine is disposed on the downstream part of the first folding machine on the conveyor belt and includes a third folding arm, a third extrude bar and a fourth extrude bar; the fourth extrude bar is disposed at the rear end of the second extrude bar and is in line with the second extrude bar; the third extrude bar is parallel to the fourth extrude bar; the distance between the third extrude bar and the fourth extrude bar is the length of the second section of the workpiece; and the third folding arm is disposed at the front end of the third extrude bar and expanded outward.

Moreover, in the system for manufacturing the picture frame, a workpiece cleaning machine is also disposed between the edge milling machine and the glue sprayer, on the conveyor belt, and includes a blower disposed on the conveyor belt and a dust collector disposed beneath the conveyor belt; and a blow-off nozzle of the blower faces notches and inclines of the workpiece.

Moreover, in the system for manufacturing the picture frame, the edge milling machine is a commercially available edge milling machine; and under the control of the control system, the inclines are milled at both ends of the wire and the three notches of which cross sections are in the shape of isosceles right-angled triangles are milled at determined positions in the middle of the wire.

Moreover, in the system for manufacturing the picture frame, the glue sprayer is disposed on the downstream part of the edge milling machine on the conveyor belt and includes five spray guns; spray heads of the spray guns are respectively opposite to the notches and the inclines of the workpiece on the conveyor belt; all the spray guns are disposed on a gantry frame; support arms on both sides of the gantry frame are cylinders which are controlled by the control system to drive the spray guns to move up and down; a detection electric eye for detecting whether the workpiece is just under the spray heads is disposed under the gantry frame; and output of the detection electric eye is connected with the control system.

Moreover, in the system for manufacturing the picture frame, the first folding machine and the second folding machine further include a first position regulator, a second position regulator and a third position regulator for regulating the position of the first extrude bar, the second extrude bar and the third extrude bar respectively.

The method and the system for manufacturing the picture frame provided by the present invention achieve the automatic production of picture frames, improve the work efficiency and have a simple and controllable production line.

Detailed description will be given below to the present invention with reference to the accompanying drawings and the embodiments.

### BRIEF DESCRIPTION OF THE DRAWINGS

FIG. 1a illustrates a wire adopted for manufacturing a picture frame;

FIG. 1b illustrates a four-section workpiece formed by the edge milling of the wire;

FIG. 1c is a side view of FIG. 1b;

FIG. 2 is a schematic diagram of the system for manufacturing the picture frame provided by the embodiment of the present invention;

FIG. 3 is a schematic diagram of a glue sprayer in the system for manufacturing the picture frame provided by the embodiment of the present invention; and

FIG. 4 is a schematic structural view of a cleaning machine in the system for manufacturing the picture frame provided by the embodiment of the present invention.

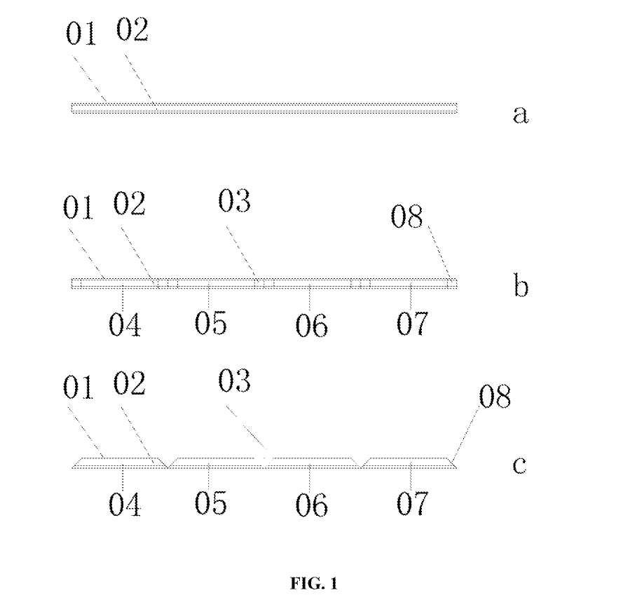

In the figures, 1. edge milling machine; 2. glue sprayer; 21. spray gun; 22. spray head; 23. gantry frame; 24. cylinder; 25. turpentine electric eye; 3. first folding machine; 31. first folding arm; 32. second folding arm; 33. first extrude bar; 34. second extrude bar; 35. first position regulator; 36. second position regulator; 4. second folding machine; 41. third folding arm; 42. third extrude bar; 43. fourth extrude bar; 44. third position regulator; 5. cleaning machine; 51. blower; 52. dust collector; 6. workpiece turnover machine; 7. conveyor belt; 8. workpiece; 81. notch; 82. incline; 83. first section; 84. second section; 85. third section; 86. fourth section.

### DETAILED DESCRIPTION OF THE PREFERRED EMBODIMENTS

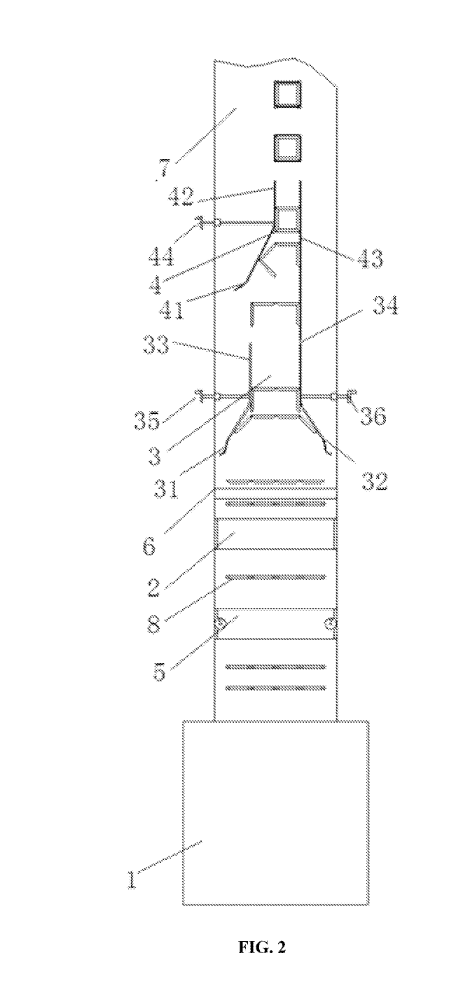

The embodiment 1 relates to a system for manufacturing a picture frame. As illustrated in FIG. 2, the system is a production line on which an edge milling machine 1, a cleaning machine 5, a glue sprayer 2, a workpiece turnover machine 6, a first automatic folding machine 3 and a second automatic folding machine 4 of an automatic picture frame folding machine are connected with each other through a conveyor belt 7 from the forehead to the tail; and the edge milling machine 1, the cleaning machine 5, the glue sprayer 2, the workpiece turnover machine 6 and the automatic picture frame folding machine are connected with each other through the conveyor belt 7. The system is controlled by a control system to operate harmoniously. A workpiece 8 formed by the edge milling of a wire through the edge milling machine 1 is subjected to various processes to finally form the picture frame.

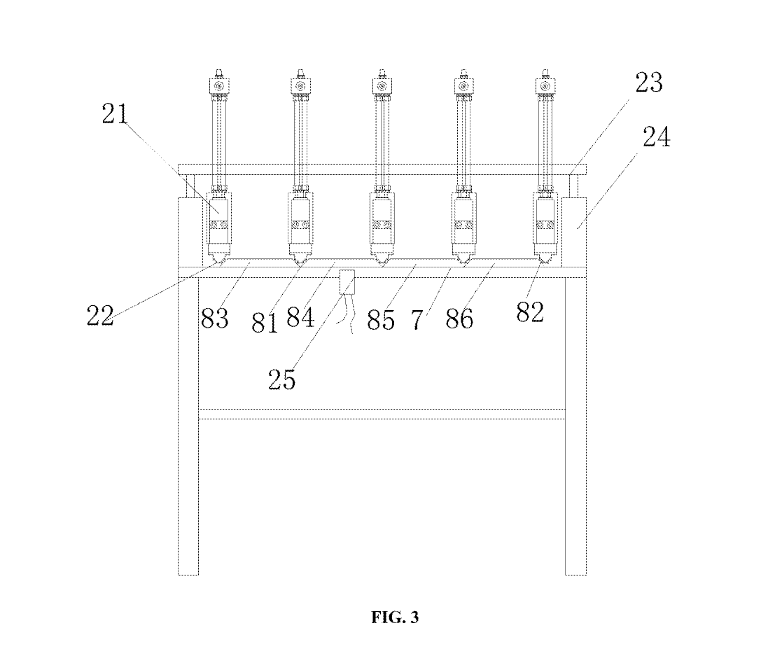

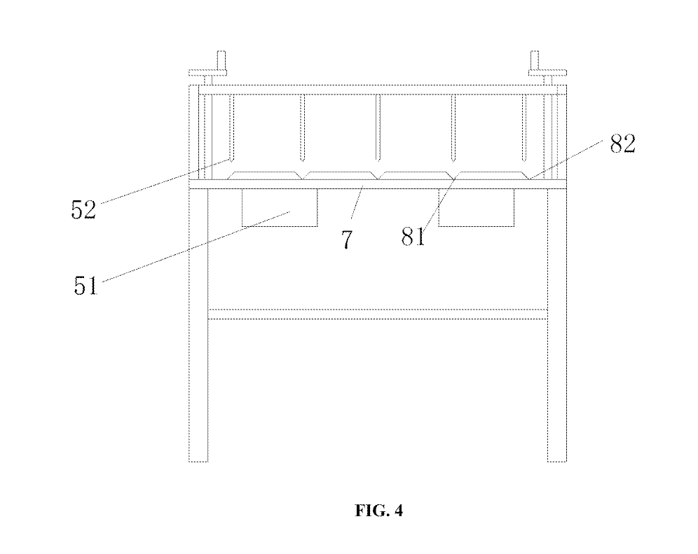

The edge milling machine 1 is disposed at the initial end of the production line and is a commercially available edge milling machine. Under the control of the control system, inclines 82 are milled at both ends of the wire by the edge milling machine; three notches 81 of which cross sections are in the shape of isosceles right-angled triangles are milled at positions in the middle of the wire; and the workpiece 8 is formed. As illustrated in FIGS. 3 and 4, the workpiece 8 consists of a first section 83, a second section 84, a third section 85 and a fourth section 86, in which the first section 83 and the third section 85 are opposite sides of the picture frame and have equal length, and the second section 84 and the fourth section 86 are opposite sides of the picture frame and have equal length. The embodiment is used for manufacturing an aluminum alloy picture frame; the first section 83, the second section 84, the third section 85 and the fourth section 86 are all made of aluminum alloy materials and formed by cutting through the edge milling machine 1.

There is milled powder on the workpiece 8 cut by the edge milling machine 1, at an outlet of the edge milling machine 1. Therefore, cleaning is required. As illustrated in FIG. 4, the cleaning machine 5 includes a blower 51 disposed on the conveyor belt 7 and a dust collector 52 disposed beneath the conveyor belt 7, and a blow-off nozzle of the blower 51 faces the notches 81 and the inclines 82 of the workpiece 8. The blower 51 is configured to blow the aluminum alloy powder on the workpiece and the dust collector 52 is configured to collect the aluminum alloy powder, so that the surface of the workpiece 8, particularly places requiring the spraying of a hot melt adhesive, e.g. the notches 81 and the inclines 82, can be clean.

After the workpiece 8 is cleaned, the hot melt adhesive can be sprayed on the notches 81 and the inclines 82. For the convenience of downward glue spraying of spray heads 22 of the glue sprayer 2, at this point, the notches 81 of the workpiece 8 are upwards. The glue sprayer 2 is disposed on the downstream part of the edge cleaning machine 1 and the cleaning machine 5 on the conveyor belt 7. As illustrated in FIGS. 2 and 3, the glue sprayer 2 includes five spray guns 21; the spray heads 22 of the spray guns 21 are respectively opposite to the notches 81 and the inclines 82 of the workpiece 8 on the conveyor belt 7; all the spray guns 21 are disposed on a gantry frame 23; support arms on both sides of the gantry frame 23 are cylinders 24 which are controlled by the control system to drive the spray guns 21 to move up and down; a detection electric eye 25 for detecting whether the workpiece 8 is just under the spray heads 22 is disposed under the gantry frame 23; and output of the detection electric eye 25 is connected with the control system. When the detection electric eye 8 detects that the workpiece 8 is just under the gantry frame 23, the detection electric eye 8 generates a signal to the control system; the control system controls the conveyor belt 7 to stop moving forward and meanwhile controls the cylinders 24 to compress to lower the gantry frame 23 until the spray heads 22 are extended into the notches 81 or the inclines 81; glue spraying is performed; and after glue spraying, the control system controls the cylinders 24 to raise the gantry frame 23 and controls the conveyor belt to move forward continuously until the detection electric eye 25 detects the next workpiece and the next glue spraying process is performed.

In the embodiment, as the glue spraying part has high requirement on glue spraying, a profiled glue spraying process is designed and a special spray gun design structure must be designed particularly. But as the design structure of a barreled polyurethane reactive (PUR) glue sprayer usually has two outlets and at least five “V”-shaped notches are required to be sprayed once for each picture frame, the structure of a transfer type midway glue station is utilized according to the special requirement of the special product to satisfy the requirement of the glue spraying of a plurality of notches and meanwhile ensure the consistency of outflow glue of each hose and each spray gun.

A workpiece turnover machine 6 for turning over the workpiece is also disposed before the workpiece enters the lower part of the glue sprayer. The machine is configured to turn over the workpiece 8 backwards for 90 degree.

After the workpiece is turned over backwards for 90 degree by the workpiece turnover machine 6, the step of workpiece folding is carried out. In the embodiment, the automatic picture frame folding machine includes the first folding machine 3 and the second folding machine 4; the first folding machine 3 is disposed on the downstream part of the glue sprayer 2 on the conveyor belt 7 and includes a first folding arm 31, a second folding arm 32, a first extrude bar 33 and a second extrude bar 34; the first extrude bar 33 and the second extrude bar 34 are disposed in parallel on the conveyor belt 7 at the distance of the total length of the second section 84 and the third section 85; the first folding arm 31 and the second folding arm 32 are symmetrically and respectively disposed at front ends of the first extrude bar 33 and the second extrude bar 34 and expanded outward; the second folding machine 4 is disposed on the downstream part of the first folding machine 3 on the conveyor belt 7 and includes a third folding arm 41, a third extrude bar 42 and a fourth extrude bar 43; the fourth extrude bar 43 is disposed at the rear end of the second extrude bar 34 and is in line with the second extrude bar 34; the third extrude bar 42 is parallel to the fourth extrude bar 43; the distance between the third extrude bar 42 and the fourth extrude bar 43 is the length of the second section 84 of the workpiece; and the third folding arm 41 is disposed at the front end of the third extrude bar 42 and expanded outward.

When the workpiece 8 transversely enters a bell mouth formed by the first folding arm 31 and the second folding arm 33 and moves forward continuously, as the bell moth is gradually narrowed from the first folding arm 31 to the second folding arm 33, the workpiece can only be bent inwards. As the workpiece is provided with three notches 81, the workpiece is folded herein. As stress points are formed at outer ends of the first section 83 and the fourth section 86, at this point, the notches on both sides are folded but the notch in the middle cannot be folded, and hence the first section 83 and the fourth section 86 are folded backwards but the second section 84 and the third section 85 are unchanged. At this point, the workpiece is disposed between the first extrude bar 32 and the second extrude bar 33 and moves forward continuously. The first section 83 and the fourth section 86 are respectively parallel to the first extrude bar 32 and the second extrude bar 34 and abut against the inside of the first extrude bar 32 and the inside of the second extrude bar 34 respectively. When the workpiece is away from the first extrude bar 32 and the second extrude bar 34 and moves forward continuously, the workpiece reaches an opening formed by the third extrude bar 42 and the third folding arm 41. At this point, the first section 83 also abuts against the third extrude bar 42 and the outer end of the third section 85 abuts against the third folding arm 41. Under the pressure of the third folding arm 41, the notch 81 between the second section 84 and the third section 85 is pressed and folded. When the workpiece is disposed between the third extrude bar 42 and the fourth extrude bar 43, the inclines 82 of the first section 83 and the fourth section 86 are combined in such a way that the first section 83, the second section 84, the third section 85 and the fourth section 86 are surrounded to form a square. And hence the picture frame is formed. Subsequently, the picture frame is solidified.

In the embodiment, in order to manufacture picture frames with different specifications, the first folding machine 3 and the second folding machine 4 further include a first position regulator 35, a second position regulator 36 and a third position regulator 44 for regulating the position of the first extrude bar 33, the second extrude bar 34 and the third extrude bar 42.

The distance between the first extrude bar 33 and the second extrude bar 34 is regulated by the first position regulator 35 and the second position regulator 36 so as to be adapted to the length between the second section and the third section of the picture frames with different specifications; and the distance between the third extrude bar 42 and the fourth extrude bar 43 is regulated by the third position regulator so as to be adapted to the length of the second section 84 of the workpiece.

What is claimed is:

1. A method for manufacturing a picture frame, adopting a wire as workpiece to manufacture the picture frame, comprising the steps of edge milling, glue application, workpiece turnover, folding and picture frame solidifying, wherein the folding step includes:
primary folding, in which notches on both sides of the workpiece are folded inwards so that a first section and a fourth section of the workpiece are respectively perpendicular to a second section and a third section; and
secondary folding, in which a notch in the middle of the workpiece is folded in such a way that the second section and the third section of the workpiece are perpendicular to each other, and at this point, inclines on both sides of the first section and the fourth section in the workpiece are overlapped to form an enclosed frame.

2. The method for manufacturing the picture frame according to claim 1, wherein the workpiece must be subjected to dust removal after edge milling

3. The method for manufacturing the picture frame according to claim 1, wherein in the step of edge milling, three notches of which cross sections are in the shape of isosceles right-angled triangles are milled on the wire to divide the wire into four sections to form the workpiece, in which the first section and the third section have equal length and the second section and the fourth section have equal length; and an incline with the angle of 45 degree is respectively milled at head and tail of the wire.

4. The method for manufacturing the picture frame according to claim 1, wherein in the gluing step, hot-melt adhesive guns are adopted to spray a hot melt adhesive on the three notches and the two inclines in the workpiece at the same time.

5. The method for manufacturing the picture frame according to claim 1, wherein in the step of workpiece turnover, the workpiece after glue spraying is turned over 90 degree.

6. A system for manufacturing a picture frame of the method for manufacturing the picture frame according to claim 1, comprising a control system, an edge milling machine and a glue sprayer, further comprising a workpiece turnover machine (6), an automatic picture frame folding machine and a conveyor belt (7) for connecting the edge milling machine (1), the glue sprayer (2) and the automatic picture frame folding machine, wherein
the automatic picture frame folding machine includes a first folding machine (3) and a second folding machine (4); the first folding machine (3) is disposed on the downstream part of the glue sprayer (2) on the conveyor belt (7) and includes a first folding arm (31), a second folding arm (32), a first extrude bar (33) and a second extrude bar (34); the first extrude bar (33) and the second extrude bar (34) are disposed in parallel on the conveyor belt (7) at the distance of the total length of a second section (84) and a third section (85) in a workpiece (8); the first folding arm (31) and the second folding arm (32) are respectively disposed at front ends of the first extrude bar (33) and the second extrude bar (34) and expanded outward; and
the second folding machine (4) is disposed on the downstream part of the first folding machine (3) on the conveyor belt (7) and includes a third folding arm (41), a third extrude bar (42) and a fourth extrude bar (43); the fourth extrude bar (43) is disposed at the rear end of the second extrude bar (34) and is in line with the second extrude bar (34); the third extrude bar (42) is parallel to the fourth extrude bar (43); the distance between the third extrude bar (42) and the fourth extrude bar (43) is the length of the second section (84) of the workpiece; and the third folding arm (41) is disposed at the front end of the third extrude bar (42) and expanded outward.

7. The system for manufacturing the picture frame according to claim 6, wherein a workpiece cleaning machine (5) is also disposed between the edge milling machine (1) and the glue sprayer (2), on the conveyor belt (7), and includes a blower (51) disposed on the conveyor belt (7) and a dust collector (52) disposed beneath the conveyor belt (7); and a blow-off nozzle of the blower (51) faces notches (81) and inclines (82) of the workpiece (8).

8. The system for manufacturing the picture frame according to claim 6, wherein the edge milling machine (1) is a commercially available edge milling machine; and under the control of the control system, the inclines are milled at both ends of the wire and the three notches of which cross sections are in the shape of isosceles right-angled triangles are milled at determined positions in the middle of the wire.

9. The system for manufacturing the picture frame according to claim 6, wherein the glue sprayer (2) is disposed on the downstream part of the edge milling machine (1) on the conveyor belt (7) and includes five spray guns (21); spray heads (22) of the spray guns (21) are respectively opposite to the notches (81) and the inclines (82) of the workpiece (8) on the conveyor belt (7); all the spray guns (21) are disposed on a gantry frame (23); support arms on both sides of the gantry frame (23) are cylinders (24) which are controlled by the control system to drive the spray guns (21) to move up and down; a detection electric eye (25) for detecting whether the workpiece (8) is just under the spray heads (22) is disposed under the gantry frame (23); and output of the detection electric eye (25) is connected with the control system.

10. The system for manufacturing the picture frame according to claim 6, wherein the first folding machine (3) and the second folding machine (4) further include a first position regulator (35), a second position regulator (36) and a third position regulator (44) for regulating the position of the first extrude bar (33), the second extrude bar (34) and the third extrude bar (42) respectively.
